(19) United States
(12) Patent Application Publication
(10) Pub. No.: US 2010/0178391 A1
(43) Pub. Date: Jul. 15, 2010

(54) FLEXIBLE PAD FOR PREPARING A BEVERAGE

(76) Inventors: John MacMahon, Oxon (GB); Mark Norton, Oxon (GB); Phil Brown, Oxon (GB); Rodett Susan, Glenview, IL (US); Audrey Trouillot, Oxon (GB); ray Laudano, Glenview, IL (US); Adam Fennel, Oxon (GB); Satwinder Panesar, Oxon (GB); Lee Rowan, Oxon (GB); James Ferguson, Oxon (GB); Heather Hudson, Glenview, IL (US); Anilkumar Gaonkar, Buffalo Grove, IL (US); Bary Zeller, Glenview, IL (US)

Correspondence Address: FITCH EVEN TABIN & FLANNERY, 120 SOUTH LASALLE STREET, SUITE 1600, CHICAGO, IL, 60603-3406, US

(21) Appl. No.: 11/577,078

(22) PCT Filed: Oct. 24, 2005
(86) PCT No.: PCT/GB2005/004108

§ 371 Date: Sep. 1, 2009

(30) Foreign Application Priority Data
Oct. 22, 2004 (GB) 0423533.9

(51) Int. Cl. B65B 29/02; A23F 5/26

(52) U.S. Cl. 426/78; 426/431

(57) ABSTRACT

The present invention provides a flexible pad for preparing a beverage comprising: a filter bag defining a storage volume; the storage volume containing a water-soluble composition or a combination or mixture of water-soluble compositions for forming a beverage; wherein the storage volume further contains one or more absorbent elements.

The present invention relates to improvements in flexible pads for preparing beverages which contain a water soluble substance. The water soluble substance may be a powdered ingredient for making a beverage such as coffee, tea or soup, fruit juice and desserts. The invention finds particular advantage where the water soluble substance is a milk powder or creamer powder. The pads are also known as pods, cartridges, capsules, pouches and bags.

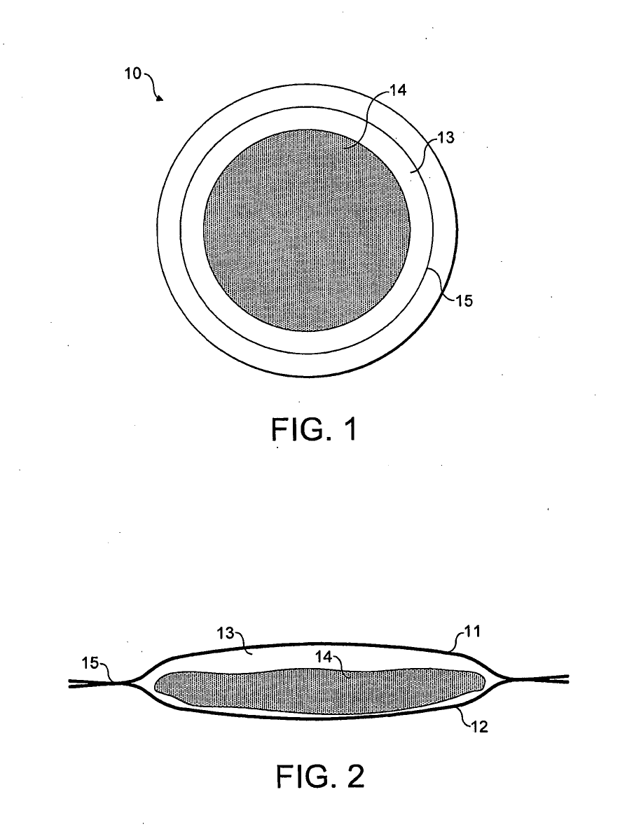

An example of a known pad is shown in FIGS. 1 and 2. The pad 10 is simple in construction and comprises a circular upper sheet 11 and a circular lower sheet 12 of filter material which are bonded together around a peripheral seam 15 to define and seal a storage volume 13 in which the water soluble substance 14 is contained. In use, the pad 10 is placed in a beverage preparation machine such as a coffee brewer and heated water is passed through the pad 10. The heated water flows through the upper sheet 11 and lower sheet 12 of filter material and in so doing contacts and dissolves the water soluble substance 14 contained in the storage volume 13 to form the beverage. The beverage then passes through the lower sheet 12 of the filter material and is dispensed into a suitable receptacle. The water soluble substance may be used to form the whole or part of a beverage. Where the water soluble substance is a milk powder or creamer powder, the pad may be used to form a milk- or creamer-based beverage or to form a milk- or creamer-based portion of an alternative beverage such as coffee.

Pads with creamer powders or milk based products may be used in dispensing cappuccino-style beverages. Such pads may be used in the beverage preparation machine on their own to dispense a milky, creamy or frothy beverage portion onto an already dispensed beverage, such as coffee. Alternatively, the pad containing the creamer powder or milk-based substance may be used in the beverage preparation machine in combination with a pad containing a substance for producing another beverage portion. For example, two pads may be used at the same time in the machine, one pad containing a creamer powder and one pad containing roast and ground coffee as taught in EP0756844. In this way, a complete beverage may be dispensed in one operation cycle of the beverage preparation machine.

The pads described above are similar to well known tea bags which are used for infusing hot water with tea leaves. However, there are a number of particular problems in using such flexible pads in beverage preparation machines where the pads contain a water soluble product such as a milk powder or creamer powder as opposed to a product which is infused in water but is not itself dissolved, such as roast and ground coffee or tea leaves. One disadvantage is that as the water soluble substance 14 is dissolved by the water passing through the pad, the pad tends to collapse in on itself bringing the upper sheet 11 and lower sheet 12 of filter material into contact with one another. In addition, because the dissolution of the water soluble substance 14 is not necessarily uniform throughout the storage volume of the pad 10 during use this can lead to portions of the filter material collapsing before the whole or a substantially part of the water soluble substance 14 has been dissolved. Where the upper sheet 11 and the lower sheet 12 of filter material contact one another, there is formed a low resistance flow path for the heated water. As a result, as soon as the pad 10 starts to collapse, the heated water has a tendency to flow through the portions of the pad 10 where the upper sheet 11 and lower sheet 12 are in contact rather than flowing more uniformly through the entire storage volume of the pad 10. This problem is exacerbated where the pad is used in a beverage preparation machine together with another pad containing another beverage portion as described above. It is preferred in such one-step dispensing of a beverage that the pad containing the infusible substance such as roast and ground coffee is placed on top of the pad containing the water soluble product so as to ensure proper extraction of the infusible substance as taught in EP0756844. However, the additional weight of the pad containing the infusible substance increases the likelihood that the pad containing the water soluble substance will collapse during the dispense cycle. For these reasons, use of pads such as those shown in FIGS. 1 and 2 can lead to substantial portions of the water soluble substance 14 being left within the pad 10 after the beverage preparation machine has completed its dispense cycle. Experiments show that for commonly used creamer powders as much as 40 to 60% of the creamer powder remains in the pad at the end of the dispense cycle. (The actual amount left depends to some extent on the dissolution properties of the creamer powder. Typically, the rate of flow of water is such that the beverage is prepared in under one minute. It is known with some compositions to include filler agents. This may result in poorer dissolution of the composition and an increased amount remaining in the pad after use. In contrast, the dissolution properties can be improved by use of agents such as surfactants. However, use of such agents has been found to result in only limited reduction in the amount of the substance left in the pad after use). This disadvantage of this simple pad arrangement is that it can lead to a beverage or beverage portion being dispensed which is weaker than intended and also leads to wastage of the water soluble substance 14. Weak beverages can also be dispended where the ingredients or part of the ingredients are by-passed by part of the water flow during dispensation.

Attempts have been made to overcome this problem by providing a form-retaining stiffening body within the interior of the storage volume 13. EP1398279 discloses use of a form-providing stiffening body comprising a grid structure that itself comprises a compartmenting wall configuration that spans between the upper and lower sheets of the flexible pad. Whilst the form-providing stiffening body prevents collapse of the pad and contact of the upper sheet and lower sheet of filter material, the structure described is complex and increases the cost and complexity of manufacture compared to the simpler pad as shown in FIGS. 1 and 2. In addition, the compartmenting wall configuration of the pad necessitates more careful filling of the storage volume with the water soluble substance to ensure consistent filling of the compartments.

Another disadvantage with the simple flexible pads of FIGS. 1 and 2 and the pad of EP1398279 is that, after use, the pad is left in a very wet state which is unpleasant for a user to handle when removing the pad manually from the beverage preparation machine. This can lead to dripping and soiling of the machine and surroundings as the pad is transported to a waste receptacle.

A further disadvantage of the known pads and the pads of EP1398279 is that, because substantial quantities of the water soluble substance can typically be left within the pad even at the end of a dispense cycle, the pad-holding section of the beverage preparation machine is left in a soiled state which is contaminated with beverage. As a result, the machine must be cleaned before a next beverage can be hygienically dispensed. The cleaning either involves manually disassembling the beverage preparation machine and washing the parts or by running another dispense cycle with no pad within the pad holding section so as to flush the beverage preparation machine. Both of these methods involves extra time and inconvenience to the user.

It is an object of the present invention to provide a pad which helps to alleviate these disadvantages.

Accordingly, the present invention provides a flexible pad for preparing a beverage comprising:

a filter bag defining a storage volume;

the storage volume containing a water-soluble composition or a combination or mixture of water-soluble compositions for forming a beverage;

wherein the storage volume further contains one or more absorbent elements.

An advantage of the flexible pad of the present invention is that the one or more absorbent elements provide a structure which prevents collapse of the filter bag. In addition, the absorbent elements act as a manifold to disperse water flow and to improve dissolution. The one or more absorbent elements provide an inexpensive and straightforward mechanism for improving the dissolution of the water soluble substance contained in the storage volume of the flexible pad by ensuring that the pad does not collapse during the dispense cycle. The provision of one or more absorbent elements in the storage volume does not greatly complicate the structure of the pad and leads to minimal additional complexity in the manufacturing process.

Typically, the one or more absorbent elements contact, in use, the filter bag. The physical contact between the one or more absorbent element and the filter bag acts to prevent collapse of the filter bag.

The filter bag is typically formed from an upper sheet and a lower sheet of filter material. The one or more absorbent elements help prevent the upper sheet and lower sheet of the filtering material coming into contact with one another during use and as a result help to prevent the formation of low resistance short-circuits for water flow through the pad.

The upper sheet and lower sheet may be initially separate and then sealed around a periphery to form the filter bag. Alternatively, the upper sheet and lower sheet may be formed from a single piece of filter material which is folded and sealed to form the filter bag.

In another embodiment wherein the filter bag is formed from an absorbent material, such as a spongiform material. The absorbent filter bag may itself comprise additional absorbent elements or may instead rely on the absorbent and filtering properties of the absorbent filter bag for proper filtration of the through-flowing water.

In one embodiment, before exposure to liquid, the one or more absorbent elements take the form of, or are compressed into the form of, a sheet or sheets. By using a compressed form the dimensions and volume of the one or more absorbent elements before dispensing may be minimised. This helps to reduce the overall size of the pads allowing for smaller packages of pads to be produced. The sheet or sheets of absorbent material may comprise one or more apertures. These apertures, on a large scale compared to the pores of the absorbent material, allow through flow of water in use.

Before exposure to liquid, the sheet or sheets may have a thickness of between 0.1 and 5 mm. Preferably, on exposure to liquid, the sheet or sheets are expandable so as to have a thickness of between 5 and 35 mm. The expansion in thickness of the material may be between 100 and 1000%. Preferably, the expansion in thickness of the material is between 400 and 500%.

Advantageously during the dispense cycle as the one or more absorbent elements are contacted by water they expand. The expansion may be as a result of the physical properties or chemical properties of the material of the absorbent elements or a combination of these factors.

In another embodiment, before exposure to liquid, the one or more absorbent elements take the form of a porous mass or masses. In this embodiment the one or more absorbent elements are at all times in an expanded form.

A special advantage of the present invention is that the one or more absorbent elements act as a support means for spacing apart the upper and the lower sheet of the filter bag. This prevents collapse of the filter bag both from the affects of the water flow through the pad and or the weight of any additional pad placed in use on the flexible pad as described above.

The one or more absorbent elements may be disc shaped.

The one or more absorbent elements may be located at or near a periphery of the filter bag. The one or more absorbent elements may be ring shaped or have other geometric forms.

When expanded, an upper surface and a lower surface of the one or more absorbent elements may be substantially parallel to one another.

When expanded, one or more of an upper surface and a lower surface of the one or more absorbent elements may be convexly or concavely shaped. Alternatively, when expanded, one or more of an upper surface and a lower surface of the one or more absorbent elements may be convoluted. It is believed that shaping the upper and or lower surface of the one or more absorbent elements aids water dispersion and dissolution of the water soluble substance.

It is advantageous in the present invention that, in use, the one or more absorbent elements may act as an absorbent means for retaining excess moisture. The water retaining properties of the absorbent elements help to retain by capillary or other action the majority of any excess water that is left within the pad after the end of the dispense cycle. As a result the user may pick up the used pad and remove it to a waste receptacle with less soiling or dripping. In addition, the water absorbency of the absorbent elements means that less liquid is left in the pad holding section of the beverage preparation machine. As a consequence, cleaning of the machine is made easier.

In one embodiment, the flexible pad contains a single absorbent element.

Preferably the ratio by weight of the water soluble substance to the absorbent material before use is from 20:1 to 2:1.

The filter bag may be circular with a diameter of between 30 and 110 mm. Preferred diameters for the pad are between 60 and 70 mm, between 30 and 40 mm and between 100 and 110 mm. The diameter of the pad will depend on the nature of the beverage preparation machine for use with the pads. The filter bag may be other shapes, e.g. square, so as to fit a required beverage preparation machine. The spongiform element may be circular and sized to fit the filter bag. For example, before exposure to liquid, the diameter may be 10 to 105 mm, preferably, 10 to 65 mm, or 10 to 45 mm depending on the size of the filter bag.

In a preferred embodiment, the filter bag may have a diameter of substantially 69 mm and the spongiform element may have a diameter of substantially 55 mm.

In the embodiment where the one or more absorbent elements are always expanded, the one or more absorbent elements may be separated from the water-soluble composition by means of a layer of filtering material which is non-transmissive to the water-soluble composition in dry form. The presence of the filter paper helps to prevent the water soluble substance being washed into the interior of the absorbent elements in expanded form by the through flow of water before it has had a chance to dissolve. As a result less of the substance is retained by the absorbent elements at the end of the dispense cycle.

The layer of filtering material may be bonded to one or more surfaces of the one or more absorbent elements. The bonding may be to all surfaces of the one or more absorbent elements where the elements are always in an expanded state or only to some surfaces of the absorbent elements where the elements expand in use so as to permit said expansion.

In one embodiment one or more external surfaces of the one or more absorbent elements may be provided with barrier means preventing passage of liquid therethrough. In a preferred embodiment, the barrier means is provided on a lowermost surface of the one or more absorbent elements. The barrier means may comprise an impermeable skin bonded to, or formed integrally with, the one or more absorbent elements. The use of a barrier means can be used to adjust the flow path of water through the one or more absorbent elements. In particular, the water can be prevented from passing directly vertically downwards through the elements by provision of a less water permeable barrier means on the lowermost surface. This barrier diverts the water flow sideways which improves the circulation of water through the whole of the storage volume resulting in improved dissolution of the water soluble substance. The impermeable skin may be part of the material of the absorbent elements which has differing properties or may be a secondary material which is bonded to the primary material of the absorbent elements.

In a preferred embodiment the one or more absorbent elements are spongiform. The spongiform element or elements may be any suitable material which possesses the porous and water-retaining characteristics of a sponge. The one or more spongiform elements may be formed from compressed cellulose sponge. Examples of suitable compressed sponge include the compressed cellulose sponge products F-11, F-12 and F-13 Wet Pack sponges manufactured by 3M. The compressed sponge exhibits good expansion behaviour in contact with water and has good water absorbency in the expanded state. The sponge is stable and is of food grade quality which is suitable for storing in contact with beverage ingredients. The spongiform elements or particles may be any suitable material which possesses the porous and water-retaining characteristics of a sponge. For example, compressed sponge or natural sponge. Dried seaweed can form a suitable alternative material.

In one embodiment the one or more absorbent elements interact with water in use such as to absorb water only during a portion of a dispense cycle. For example, the one or more absorbent elements or particles may interact with water at a predetermined temperature, pH or a start of a specified chemical reaction. Preferably, the one or more absorbent elements comprise a soluble coating which, in use, is dissolvable in water to allow absorption of water to take place. For example, the soluble coating may comprise sugar or gelatine.

Alternatively the one or more absorbent elements may be made of an hydrogel, starch or a mixture of one or more of spongiform, hydrogel and starch materials. Further, the one or more absorbent elements may be formed from foamed plastic.

Preferably, the water-soluble composition is agglomerated. The agglomerated water-soluble composition may be produced by contacting the water-soluble composition with steam, water, or aqueous solution or dispersion to effect agglomeration, and optionally, either simultaneously or subsequently drying the agglomerated composition. In a comparison test, the amount of powder residue left in a standard pad was reduced from 50% to 35% when using an agglomerated powder rather than a non-agglomerated powder.

For the purposes of the present invention, water-soluble substances or compositions are defined as substances which wholly or substantially dissolve in the presence of a solvent which will typically be water. The ingredient composition of the substance before and after dissolution is substantially the same (excluding the diluting effect of the solvent). Thus, water-soluble substances exclude infusible substances such as roast and ground coffee and leaf tea. With infusible substances the ingredient composition of the infusion is substantially different to the ingredient composition of the infusible or extractable precursor since the infusion only contains certain flavour and/or aromatic qualities of the infusible substance. Examples of water-soluble substances according to the present invention include compositions such as milk powder, creamer powder, instant whitener, instant coffee, instant tea, instant soup, instant chocolate drink, sugar, instant fruit juice and instant dessert powders.

Preferably, the water-soluble composition is a milk powder or creamer powder. The fat component of the milk powder or creamer powder may have a melting point of 10 to 40 degrees Celsius.

The milk powder or creamer powder may be a dairy or non-dairy spray-dried coffee creamer or coffee whitener.

The creamer powder may comprise one or more of vegetable fat, milk proteins, emulsifiers, stabilisers, foaming agents, milk fat, soy proteins, modified starches, carriers, fillers, sweeteners, flavours, colours, nutrients, preservatives and flow agents.

The present invention also provides a flexible pad for preparing a beverage comprising a filter bag formed from a spongiform material, the filter bag containing a water-soluble composition, or a combination or mixture of water-soluble compositions for forming a beverage.

The filter bag may comprise a void space defining a storage volume containing the water-soluble composition.

Alternatively, the water-soluble composition may be held prior to dispensation, within pores of the spongiform material.

The spongiform material may have a pore size of 1 to 100 microns.

The present invention also provides a beverage brewing kit comprising a first flexible pad as described above in combination with a second flexible pad containing one or more beverage ingredients suitable for brewing. The second flexible pad may contain roast and ground coffee. The first and second pads may be joined prior to use or may be separate.

The present invention further provides a method of dispensing a beverage using a flexible pad as described above comprising the step of passing water downwardly through the flexible pad such that beverage initially exits the flexible pad through a lowermost surface thereof.

Alternatively water may pass upwardly through the flexible pad such that beverage initially exits the flexible pad through an uppermost surface thereof.

Alternatively the flexible pad may be orientated in a non-horizontal orientation, such as a vertical orientation, and water passed in a vertical or non-vertical direction through the flexible pad.

Flow of water through the pad may be substantially parallel to a major axis of the pad or substantially cross-ways to a major axis of the pad or in a direction part-way between parallel flow and cross flow.

Preferably water is passed through the flexible pad at a temperature greater than 70 degrees Celsius.

Optionally water is passed through the flexible pad as a discontinuous flow. Optionally, water is in the form of a pulsed flow.

A beverage is prepared using the pads of the present invention by inserting the pads in a beverage preparation machine. The pads may be used in a variety of beverage preparation machines. In one example, the beverage preparation machine generally comprises a housing containing a water heater, a water pump, optionally an air compressor, a control processor, a user interface and a head. The head in turn generally comprises a holder for holding, in use, the pad. The beverage preparation machine is also provided with a water tank.

The housing comprises a dispense station where dispensation of the beverage takes place. The dispense station comprises a receptacle stand having a hollow interior forming a drip tray.

The head is located towards the top of the housing above the receptacle stand. The holder of the head is shaped to receive the pad of the present invention and to hold the pad in the correct orientation such that water may be passed through the pad. Preferably the holder and head are provided with sealing means for sealing around a periphery of the pad to prevent by-pass flow of water in use. The head may be designed to direct flow of water downwardly through the pad so that beverage exits the pad through a lowermost surface of the pad. Alternatively, the head may be designed to direct flow of water upwardly through the pad so that beverage initially exits the pad through an uppermost surface of the pad before being ultimately directed downwardly to a receptacle. Of course the pad may be used in an orientation other than horizontal, for example, in a vertical orientation.

The user interface is located on the front of the housing and comprises a start/stop button, and a plurality of status indicators.

The start/stop button controls commencement of the operating cycle and is a manually operated push-button, switch or similar.

The water tank is located to the rear of the housing and is connected in use to a water tank station located at a rear half of the housing.

The water pump is operatively connected between the water tank and the water heater and is controlled by the control processor.

The water heater is located in the interior of the housing. The heater is able to heat water received from the water pump from a starting temperature of approximately 20° C. to an operating temperature of around 85° C. in under 1 minute.

The control processor of the beverage preparation machine comprises a processing module and a memory. The control processor is operatively connected to, and controls operation of, the water heater, water pump, air compressor and user interface.

Embodiments of the present invention will now be described, by way of example, with reference to the accompanying drawings in which:

FIG. 1 is an upper plan view of a prior art flexible pad;

FIG. 2 is a cross-sectional view of the flexible pad of FIG. 1;

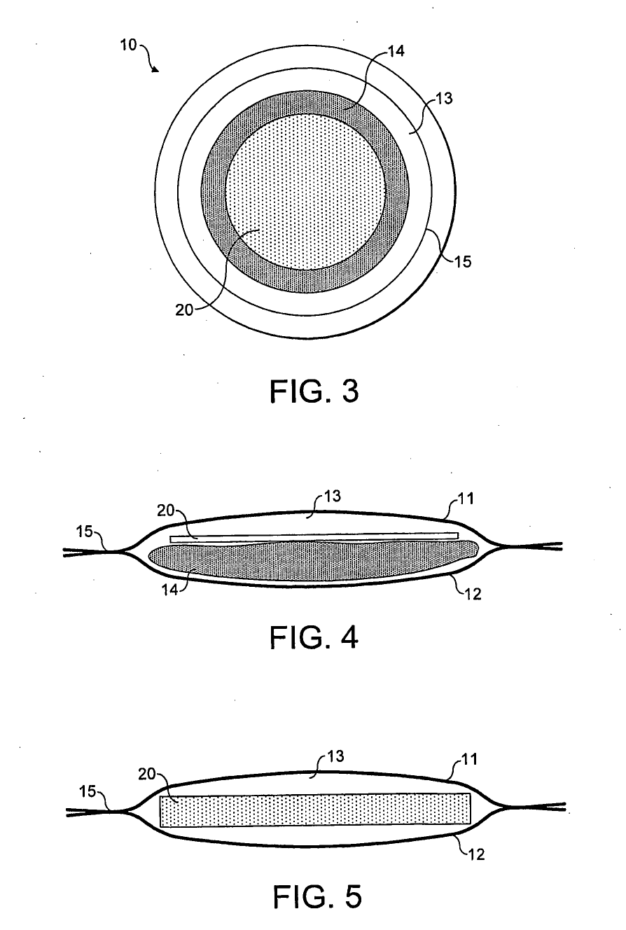

FIG. 3 is a top plan view of a first embodiment of flexible pad according to the present invention prior to use;

FIG. 4 is a cross-sectional view of the flexible pad of FIG. 3, again prior to use;

FIG. 5 is a cross-sectional view of the flexible pad of FIG. 3 after use;

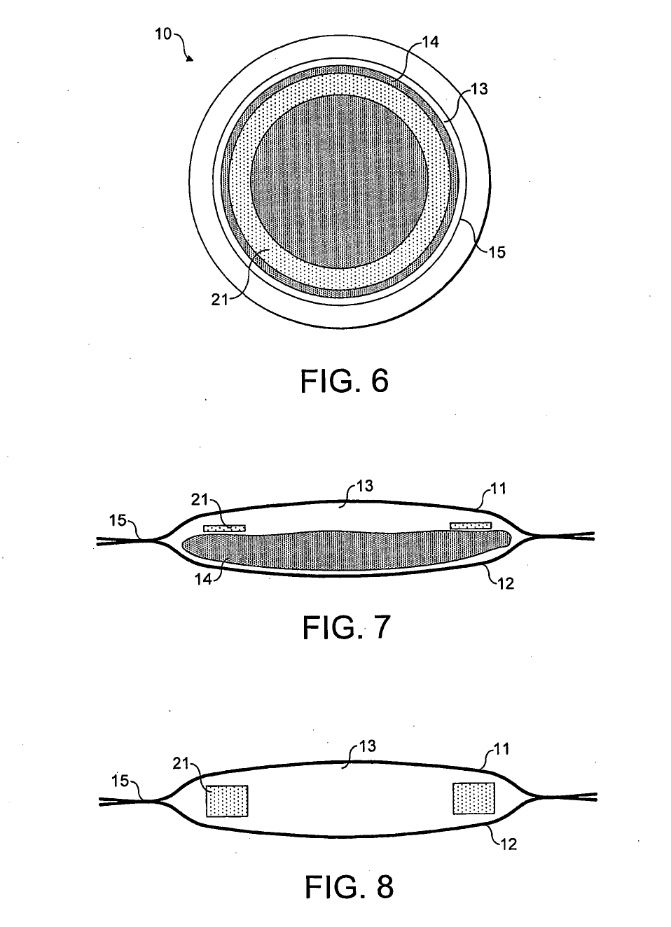

FIG. 6 is a top plan view of a second embodiment of flexible pad according to the present invention prior to use;

FIG. 7 is a cross-sectional view of the flexible pad of FIG. 6, again prior to use;

FIG. 8 is a cross-sectional view of the flexible pad of FIG. 6 after use;

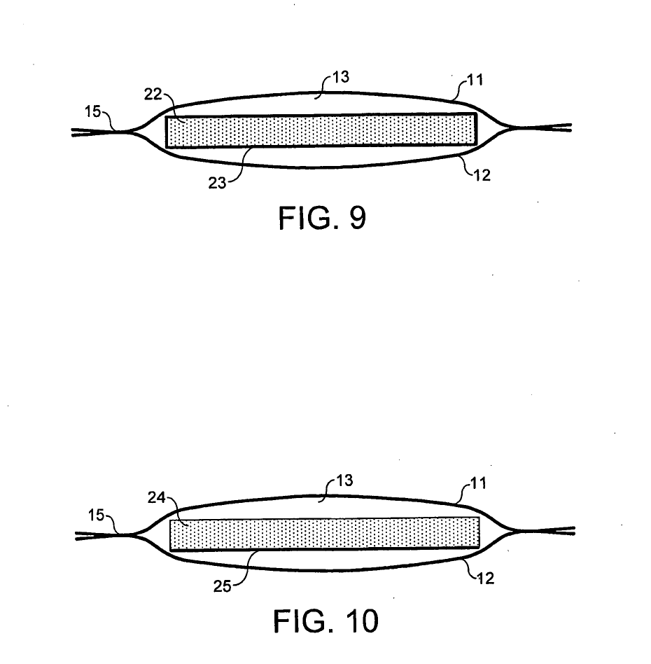

FIG. 9 is a cross-sectional view of a third embodiment of flexible pad according to the present invention, after use; and

FIG. 10 is a cross-sectional view of a fourth embodiment of flexible pad according to the present invention, after use.

FIGS. 3 to 5 illustrate a first embodiment of flexible pad according to the present invention. As with the prior art pad of FIGS. 1 and 2, the pad 10 comprises an upper sheet 11 and lower sheet 12 of filter material which are joined by heat, adhesive or similar means around a periphery seam 15 to define a storage volume 13. The pad 10 has a diameter of between 30 and 110 mm. Preferred diameters for the pad are between 60 and 70 mm, between 30 and 40 mm and between 100 and 110 mm. The storage volume 13 contains a water soluble substance 14 which when dissolved in water will form a beverage or beverage portion. The invention finds particular application where the water soluble substance 14 is a milk powder or creamer powder. Milk powders include dried skimmed milk, part-skimmed milk, and whole milk, dried milk protein concentrates, isolates, and fractions, or any combination thereof. Creamer powders can be manufactured from dairy and/or non-dairy food ingredients and typically contain emulsified fat, stabilized by protein or modified starch, dispersed in a carrier that facilitates drying, especially spray drying. Optional ingredients include buffers, flavours, colours, fillers, sweeteners, foaming agents, flow agents, nutrients, preservatives, and the like. Milk powders and creamer powders are particularly useful as coffee whiteners for brewed, soluble, and flavoured coffee products, including latte and cappuccino. In the following description, for example only, the water soluble substance will be described as a creamer powder unless the context otherwise requires.

The creamer powder may for example comprise the following by weight:

| | |
|---|---|
| Hardened vegetable fat | 49% |
| Glucose syrup | 41% |
| Sodium Caseinate | 4.5% |
| Polyphosphates - K2HPO4 | 2.0% |
| Na-Polyphosphate | 2.5% |
| Silicon dioxide | 0.25% |
| Emulsifier (Sodium stearoyl-2-lactylate) | 0.75% |

Other compositions may be used which contain fillers such as lactose and additional stabilisers. Additional emulsifiers may be added to improve wetting. Advantageously, the creamer may be provided in an agglomerated form to assist and improve solubility. Advantageously, the creamer powder may comprise a low melting temperature fat having a melting temperature of between 10 and 40 degrees Celsius. Some or all of the fat content of the composition noted above may be substituted for low melting temperature fat. In one example the composition comprises 24% low melting temperature fat and 25% fat with a melting temperature of above 40 degrees Celsius. This results in a reduction of creamer powder residue in the pad of around 15 to 20%.

The storage volume 13 also contains an absorbent spongiform element in the form of a circular disc 20 of compressed sponge material. The disc has preferred diameters of 100 to 100 mm, 50 to 59 mm and 30 to 40 mm and a thickness of 3 mm. The disc 20 is formed from cellulose sponge such as that manufactured by 3M. Other suitable materials for the spongiform element include other food grade materials with similar physical properties to those of cellulose sponge in terms of there porosity and or expandability.

Prior to use of the flexible pad 10, the pad 10 and its contents are dry. If necessary, the pad 10 can be supplied in an hermetically sealed package to prevent moisture ingress or absorption.

As shown in FIG. 4, the compressed sponge disc 20 may be positioned on top of the creamer powder 14 within the storage chamber 13. Alternatively, the compressed sponge 20 may be positioned underneath the creamer powder 14 or within the mass of the creamer powder 14.

In use, the flexible pad 10 is placed in a suitable beverage preparation machine and water is passed through the pad 10. Preferably the water is hot water where the water soluble substance is a creamer powder. The water is free to pass through the upper sheet 11 of the filter material and the lower sheet 12 of the filter material. On contact with the water, the compressed sponge 20 rapidly expands. In the expanded state the disc 20 has a thickness of between 10 and 20 mm, preferably 15 mm. Thus, the action of the liquid on the compressed sponge 20 is to produce an expansion in the thickness of the compressed sponge 20 of around 500%. The compressed sponge 20 may be configured to expand generally only in one dimension, i.e. its thickness, or may be configured to expand three-dimensionally, i.e. to increase it's thickness and also it's diameter. Water is able to pass through the expanded compressed sponge 20 substantially unhindered. As a result, the water quickly contacts and dissolves the creamer powder 14 to produce the milk based beverage or beverage portion. The beverage containing the dissolved creamer powder 14 passes through the lower filter sheet 18 and out of the beverage preparation machine.

In its expanded state shown in FIG. 5, the spongiform element 20 acts to maintain a separation of the upper sheet 11 filter material and the lower sheet 12 of filter material by physically contacting both sheets. This advantageously helps to maintain the storage volume 13 as a single volume through which the water can easily circulate. In particular, the upper and lower sheets 11, 12 of the filter material are prevented from collapsing into contact with one another and thereby producing a low resistance flow path for water. In addition, the presence of the spongiform element 20 is believed to improve the lateral spread of the water within the storage volume 13.

After use, the user of the beverage preparation machine removes the flexible pad 10 and disposes of it in a waste receptacle. Advantageously, the porous water-retaining nature of the spongiform element 20 helps to retain excess moisture that may be within the pad 10. The capillary action of the pores of the spongiform element 20 help to prevent dripping from the pad as it is transferred to a waste receptacle. In addition, the water-retaining nature of the spongiform element has the consequence that the pad holding section of the beverage preparation machine contains less moisture and hence less contamination than compared with the use of prior art pads. As a result the machine is easier to clean and prepare in readiness for the next dispense cycle.

It has been found that the presence of the spongiform element within the storage volume improves the dissolution of the creamer powder. Experiments were carried out using the pad of FIGS. 1 and 2 as a control. The experiments were carried out using a single serve brew machine that is suitable for use with such pads. It was found that with a standard creamer powder, 60% of the composition remained as residue within the pad of FIGS. 1 and 2 after the dispense cycle. With the pad 10 of FIGS. 3 to 5 the amount of creamer residue remaining within the storage volume 13 was reduced to 10 to 20%.

In an alternative version of the first embodiment, a 40 mm diameter disc of compressed sponge was utilised. The thickness of the sponge before and after exposure to water was as before. In use, the amount of creamer residue remaining within the storage volume 13 was reduced to around 13%.

FIGS. 6 to 8 illustrate a second embodiment of flexible pad. Like components to those described above in relation to the first embodiment will be referenced with like numerals and will not be described further here. Compared to the first embodiment, the second embodiment differs in that the spongiform element is provided in the form of an annular ring 21 of compressed sponge. The ring has an outer diameter of 55 mm and an inner diameter of 30 mm. The thickness of the sponge before and after exposure to water was as described in the first embodiment. The dimensions of the ring 21 are such that the material of the compressed sponge is located towards the periphery of the storage volume 13 of the flexible pad 10. As with the first embodiment, the compressed sponge 21 is shown on top of the mass of creamer powder 14. However, the sponge 21 could be placed below the creamer powder 14 or within the mass of the creamer powder 14.

Shaping the spongiform element as an annular ring rather than a disc allows for a greater flow rate of water through the central part of the pad.

In use, the amount of creamer residue remaining within the storage volume 13 with this embodiment was reduced to around 10%.

FIG. 9 illustrates a third embodiment of flexible pad according to the present invention. Again, like components have been referenced by like numerals. FIG. 9 illustrates the pad after use and after the creamer powder 14 has been dispensed. This embodiment differs in that the spongiform element 22 is provided with a covering of filter material 23. The filter material 23 preferably fully encloses the spongiform element 22 and may be bonded to one or more surfaces of the spongiform element 22. Where the spongiform element 22 is always in the expanded state (in other words not compressed prior to exposure to water) the filter material 23 may be bonded to all external surfaces of the spongiform element 22. However, where the spongiform element 22 is designed to expand in use, the filter material would not be bonded to all external surfaces but may be bonded to one or more surfaces, preferably the upper and lower surfaces, so as to allow the sponge to expand on exposure to water. The filter material 23 helps to prevent passage of the creamer powder 14 into the interior of the spongiform element 22 before it has been dissolved during dispensation. This results in improved dispensation of the water soluble substance 14 from the flexible pad. With the pad 10 of FIG. 9 the amount of the creamer powder remaining within the storage volume 13, including within the interior of the spongiform element, was reduced to 10 to 20%.

FIG. 10 illustrates a fourth embodiment of flexible pad according to the present invention. Again, like reference numerals have been used for like components. This embodiment differs in that the spongiform element 24 is provided with an impermeable barrier 25 on a lowermost surface of the spongiform element. The barrier 25 may take the form of an impermeable material which is bonded to the spongiform element 24 or alternatively may be part of the spongiform element 24 whose material characteristics are modified during manufacture so as to make it impermeable to water. For example, a sponge or foam structure with a generally open-celled construction may have one surface formed with a closed cell structure or skin by use of heat during manufacture. Results have shown that configuring the spongiform element in this manner improves the percentage of water soluble substance 14 which is dispensed from the flexible pad. With the pad 10 of FIG. 10 the amount of the creamer powder remaining within the storage volume 13 was reduced to 10 to 25%.

The flexible pad of the present invention may be provided with one or more structural supports in addition to the absorbent element which span between opposed faces of the filter bag.

In the above embodiments the pad has been described as containing a single spongiform element. More than one spongiform element may be contained in the storage volume 13.

The absorbent elements have been described in particular as spongiform. Alternatively, an hydrogel material may be used to form the element or elements. Suitable hydrogels include poly (HEMA) 2 hyroxyethyl methacrylate, polyacrylic, polyacyrylamide, Gelatine, Alginates, Agar and Carrageenan, and other hydrocolloids.

The water soluble substance has been described as preferably being a milk- or dairy-based creamer powder. However the pads of the present invention may also find application with other soluble ingredients such as instant coffee, instant tea, chocolate, soup or dessert ingredients.

The upper sheet 11 and lower sheet 12 have been described as being formed from filter material, such as that used commonly to form tea bags. However, other suitable materials may be used which are non-transmissive to the water soluble substance in the dry form but are transmissive to the water soluble substance when dissolved in water. For example, in an alternative embodiment the filter bag is formed from a spongiform material such as compressed sponge or expanded sponge. The sponge has a pore size that prevents transmission of the powdered form of the water-soluble composition but allows the dissolved composition to pass. In this embodiment the sponge filter bag may or may not include additional absorbent elements in the storage volume.

If preferred, the pad may be formed wholly of spongiform material of the types described above.

In another pad, the powdered composition of flexible pad may be held in a mass of spongiform material of the types described above with no void space forming a separate storage volume. Rather, the powdered composition is dispersed within the dry sponge pore matrix and held within the spongiform material until water is passed through the pad at which point the powdered composition is dissolved and passes out of the sponge. Preferably the pore size of the dry sponge is 1 to 100 microns, more preferably 10 to 50 microns. The spongiform material may comprise one or more through apertures of 1 to 5 mm in diameter to moderate the flow of water through the pad.

In the above description, the storage chamber 13 has been described as a unitary volume. However, the volume may be separated into multiple compartments using flexible materials. The chambers may if desired contain different beverage ingredients or the same ingredients. Some or all of the compartments may comprise absorbent bodies of the types described above. Some or all of the compartments may have dispersion discs contained therein.

The pad may be used for dispensing hot and cold beverages. Still and carbonated beverages may be produced by using still or carbonated water.

1. A flexible pad for preparing a beverage comprising:
a filter bag defining a storage volume;
the storage volume containing a water-soluble composition or a combination or mixture of water-soluble compositions for forming a beverage;
wherein the storage volume further contains one or more absorbent elements.

2. A flexible pad as claimed in claim 1 wherein the one or more absorbent elements contact, in use, the filter bag.

3. A flexible pad as claimed in claim 1 or claim 2 wherein the filter bag comprises an upper sheet and a lower sheet of filter material.

4. A flexible pad as claimed in claim 3 wherein the upper sheet and lower sheet are initially separate and are then sealed around a periphery to form the filter bag.

5. A flexible pad as claimed in claim 3 wherein the upper sheet and lower sheet are formed from a single piece of filter material which is folded and sealed to form the filter bag.

6. A flexible pad as claimed in claim 1 or claim 2 wherein the filter bag is formed from a spongiform material.

7. A flexible pad as claimed in claim 6 wherein the spongiform material is compressed or expanded sponge.

8. A flexible pad as claimed in any preceding claim wherein, before exposure to liquid, the one or more absorbent elements take the form of, or are compressed into the form of, a sheet or sheets.

9. A flexible pad as claimed in claim 8 wherein the sheet or sheets of absorbent material comprise on or more apertures.

10. A flexible pad as claimed in claim 8 or claim 9 wherein, before exposure to liquid, the sheet or sheets have a thickness of between 0.1 and 5 mm.

11. A flexible pad as claimed in claim 10 wherein, on exposure to liquid, the sheet or sheets are expandable so as to have a thickness of between 5 and 25 mm.

12. A flexible pad as claimed in claim 11 wherein the expansion in thickness of the material is between 100 and 1000%.

13. A flexible pad as claimed in any of claims 1 to 7 wherein, before exposure to liquid, the one or more absorbent elements take the form of a porous mass or masses.

14. A flexible pad as claimed in any preceding claim wherein, in use, the one or more absorbent elements act as a support means for spacing apart an upper and a lower sheet of the filter bag.

15. A flexible pad as claimed in any preceding claim wherein the one or more absorbent elements are disc shaped.

16. A flexible pad as claimed in any preceding claim wherein the one or more absorbent elements are located at or near a periphery of the filter bag.

17. A flexible pad as claimed in any preceding claim wherein the one or more absorbent elements are ring shaped.

18. A flexible pad as claimed in any preceding claim wherein, when expanded, an upper surface and a lower surface of the one or more absorbent elements are substantially parallel to one another.

19. A flexible pad as claimed in any preceding claim wherein, when expanded, one or more of an upper surface and a lower surface of the one or more absorbent elements are convexly or concavely shaped.

20. A flexible pad as claimed in any preceding claim wherein, when expanded, one or more of an upper surface and a lower surface of the one or more absorbent elements are convoluted.

21. A flexible pad as claimed in any preceding claim wherein, in use, the one or more absorbent elements act as an absorbent means for retaining excess moisture.

22. A flexible pad as claimed in any preceding claim containing a single absorbent element.

23. A flexible pad as claimed in claim 22 wherein the filter bag is circular with a diameter of between 30 and 110 mm.

24. A flexible pad as claimed in claim 23 wherein the filter bag has a diameter of substantially 69 mm and the absorbent element has a diameter of substantially 55 mm.

25. A flexible pad as claimed in any preceding claim wherein the one or more absorbent elements are separated from the water-soluble composition by means of a layer of filtering material which is non-transmissive to the water-soluble composition in dry form.

26. A flexible pad as claimed in claim 25 wherein the layer of filtering material is bonded to one or more surfaces of the one or more absorbent elements.

27. A flexible pad as claimed in any preceding claim wherein one or more external surfaces of the one or more absorbent elements are provided with barrier means preventing passage of liquid therethrough.

28. A flexible pad as claimed in claim 27 wherein the barrier means is provided on a lowermost surface of the one or more absorbent elements.

29. A flexible pad as claimed in claim 27 or claim 28 wherein the barrier means comprises an impermeable skin bonded to, or formed integrally with, the one or more absorbent elements.

30. A flexible pad as claimed in any preceding claim wherein the one or more absorbent elements are spongiform.

31. A flexible pad as claimed in claim 30 wherein the one or more spongiform elements are formed from compressed cellulose sponge.

32. A flexible pad as claimed in any of claims 1 to 29 wherein the one or more absorbent elements is made of an hydrogel, starch or a mixture of one or more of spongiform, hydrogel and starch materials.

33. A flexible pad as claimed in any preceding claim wherein the water-soluble composition is agglomerated.

34. A flexible pad as claimed in claim 33 wherein the agglomerated water-soluble composition is produced by contacting the water-soluble composition with steam, water, or aqueous solution or dispersion to effect agglomeration, and optionally, either simultaneously or subsequently drying the agglomerated composition.

35. A flexible pad as claimed in any preceding claim wherein the water-soluble composition is a milk powder or creamer powder.

36. A flexible pad as claimed in claim 35 wherein the milk powder or creamer powder is a dairy or non-dairy spray-dried coffee creamer or coffee whitener.

37. A flexible pad as claimed in claim 35 wherein a fat component of the milk powder or creamer powder has a melting point of 10 to 40 degrees Celsius.

38. A flexible pad as claimed in any of claims 35 to 37 wherein the creamer powder comprises one or more of vegetable fat, milk proteins, emulsifiers, stabilisers, foaming agents, milk fat, soy proteins, modified starches, carriers, fillers, sweeteners, flavours, colours, nutrients, preservatives and flow agents.

39. A flexible pad for preparing a beverage comprising a filter bag formed from a spongiform material, the filter bag containing a water-soluble composition, or a combination or mixture of water-soluble compositions for forming a beverage.

40. A flexible pad as claimed in claim 39 wherein the filter bag comprises a void space defining a storage volume containing the water-soluble composition.

41. A flexible pad as claimed in claim 39 wherein the water-soluble composition is held prior to dispensation, within pores of the spongiform material.

42. A flexible pad as claimed in any of claims 39 to 41 wherein the spongiform material has a pore size of 1 to 100 microns.

43. A beverage brewing kit comprising a first flexible pad as claimed in any preceding claim in combination with a second flexible pad containing one or more beverage ingredients suitable for brewing.

44. A beverage brewing kit as claimed in claim 43 wherein the second flexible pad contains roast and ground coffee.

45. A beverage brewing kit as claimed in claim 43 or claim 44 wherein the first and second pads are joined prior to use.

46. A method of dispensing a beverage using a flexible pad as claimed in any of claims 1 to 42 comprising the step of passing water downwardly through the flexible pad such that beverage initially exits the flexible pad through a lowermost surface thereof.

47. A method of dispensing a beverage using a flexible pad as claimed in any of claims 1 to 42 comprising the step of passing water upwardly through the flexible pad such that beverage initially exits the flexible pad through an uppermost surface thereof.

48. A method of dispensing a beverage using a flexible pad as claimed in any of claims 1 to 42 comprising the step of orientating the flexible pad in a non-horizontal orientation and passing water in a vertical or non-vertical direction through the flexible pad.

49. A method of dispensing a beverage using a flexible pad as claimed in any of claims 1 to 42 wherein flow of water through the pad may be substantially parallel to a major axis of the pad or substantially cross-ways to a major axis of the pad or in a direction part-way between parallel flow and cross flow.

50. A method of dispensing a beverage using a flexible pad as claimed in any of claims 1 to 42 comprising the step of passing water through the flexible pad at a temperature greater than 70 degrees Celsius.

51. A method of dispensing a beverage using a flexible pad as claimed in any of claims 1 to 42 comprising the step of passing water through the flexible pad as a discontinuous flow.

52. A method of dispensing a beverage as claimed in claim 51 wherein the discontinuous flow of water is a pulsed flow.
